(19) United States
(12) Patent Application Publication
(10) Pub. No.: US 2004/0093694 A1
(43) Pub. Date: May 20, 2004

(54) Removable handle

(76) Inventor: Annemie Anna Marie Fourie, Pretorius Park (ZA)

Correspondence Address: Lloyd L Zickert, 79 West Monroe Street, Chicago, IL, 60603, US

(21) Appl. No.: 10/399,054

(22) PCT Filed: Oct. 12, 2001
(86) PCT No.: PCT/ZA01/00159

(30) Foreign Application Priority Data
Jan. 4, 2001 (ZA) 2001-0070
Oct. 12, 2000 (ZA) 2000-5604

(51) Int. Cl. A47J 45/10

(52) U.S. Cl. 16/422; 16/425

(57) ABSTRACT

A removable handle for cookware (10) includes a casing (12) having an upper (14) and a lower (16) portion, the casing (12) being dimensioned to at least partially receive a handle of an item of cookware (not shown) and resiliently deformable zones (18) and (20) located in the casing (12), so that when the zones (18) and (20) are urged together, they grip the handle of the item of cookware. The upper (14) and lower (16) portions of the casing (12) are hingedly connected by means of hinges (22). The casing (12) is provided with a releasable securing mechanism (24) that secures the upper (14) and lower (16) portions of the casing (12) in a closed position.

### FIELD OF THE INVENTION

This invention relates to a removable handle, and, more specifically to a removable handle for an item of cookware.

### BACKGROUND TO THE INVENTION

When cookware such as, for example, pots, pans or casserole dishes, are used on a stove or in an oven, the uninsulated handles of the cookware quickly become so hot, that it is no longer possible to pick the item of cookware up with one's bare hands.

In order to alleviate this problem, items of cookware are provided with handles that do not heat up readily and/ or that do not readily store heat such as, for example, wooden handles or handles manufactured from a suitable metal. However, even such handles do heat up after a period of time, again making it difficult to pick up the item of cookware with one's bare hands.

Oven cloths or oven gloves can also be used to pick up hot items of cookware, but the grip provided by an oven cloth or oven glove is often very weak, making it difficult to pick up heavier items without running the risk of them being dropped.

The inventor therefore believes, that a need exists for a device that will allow a user to pick up or handle an item of cookware without the hands of the user being burnt, even if said item has been exposed to heat for lengthy periods of time.

### SUMMARY OF THE INVENTION

Thus, according to the invention there is provided a removable handle for cookware including:

a casing having an upper and a lower portion, the casing being dimensioned to at least partially receive a handle of an item of cookware.

The removable handle may include resiliently deformable zones located in the casing, so that when the zones are urged together, they grip the handle of the item of cookware.

The upper and lower portions of the casing may be hingedly connected. The hinge may form an integral part of the casing or may be separately mounted.

The casing may be provided with a releasable securing mechanism that secures the upper and lower portions of the casing in a closed position.

The securing mechanism may be in the form of a releasable catch. The catch may include at least one toothed member having one or more teeth.

In use, the securing mechanism secures the upper and lower portions in a closed position when a user is using the removable handle and is released when the user wishes to remove the removable handle from the item of cookware.

The zones may be releasably attached to the upper and lower portions of the casing by way of any suitable attachment means such as, for example, a press-stud arrangement, a snap-fit arrangement or a hook and loop arrangement. In this way, the resiliently deformable zones may be replaced should they suffer from wear and tear.

The zones may be of a segmented structure to allow them to be resiliently deformable such as, for example, a ribbed structure or a honeycomb struture.

The zones may be manufactured from a heat resistant material selected from the group including: wood, cork, natural rubber, synthetic rubber, nylon, any suitable polypropylene and synthetic plastics material.

At least a portion of the removable handle may be manufactured from an insulating material so as to avoid the handle becoming hot when handling a hot item of cookware.

The upper and lower portions of the casing may be shaped so as to allow easy gripping thereof by a user.

The casing may be manufactured from a suitable heat-resistant synthetic plastics material or a material of plant origin such as wood or cork.

The removable handle may be provided in a range of sizes to accommodate different sizes of handles. In particular, the handle may be shaped to accommodate handles found on pots, casserole dishes, woks, pans and the like.

Each different size of removable handle may be provided in a different colour to allow easy differentiation between the handles, however, any size may be made in any colour.

The invention extends to a set of removable handles including a plurality of removable handles as described above. Typically, for two-handled cookware the handles are provided in sets of two, each removable handle being configured to be used on one handle of an item of cookware, however, the handles may be provided individually.

### DETAILED DESCRIPTION OF THE INVENTION

The invention will now be described by way of the following non-limiting example with reference to the accompanying drawings.

In the drawings:

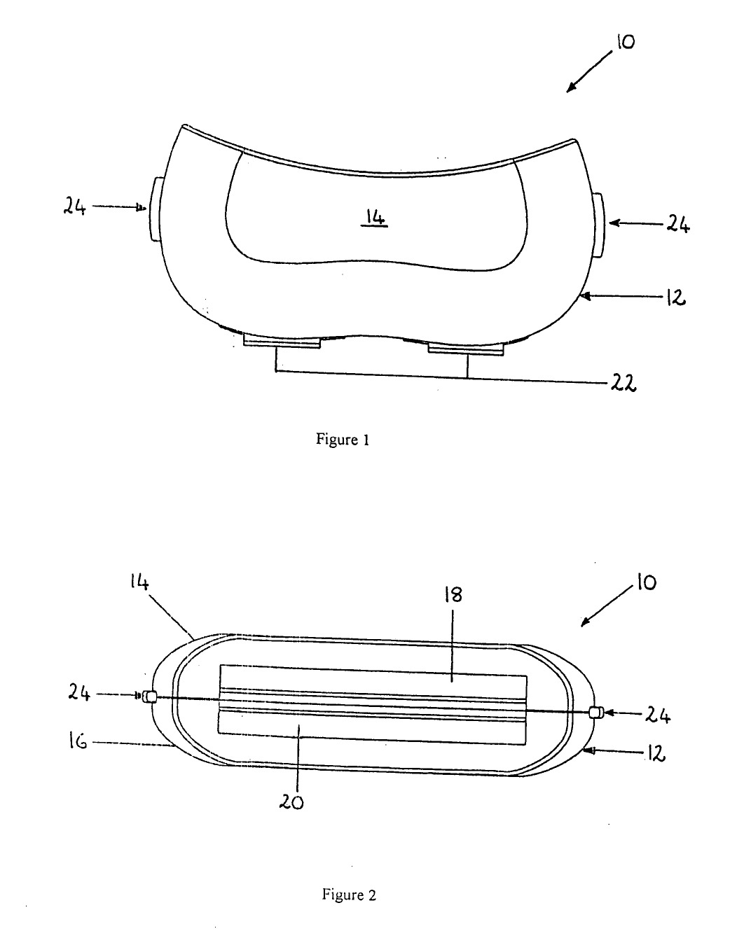

FIG. 1 shows a plan view of an embodiment of a removable handle in accordance with the present invention;

FIG. 2 shows a front view of the handle of FIG. 1;

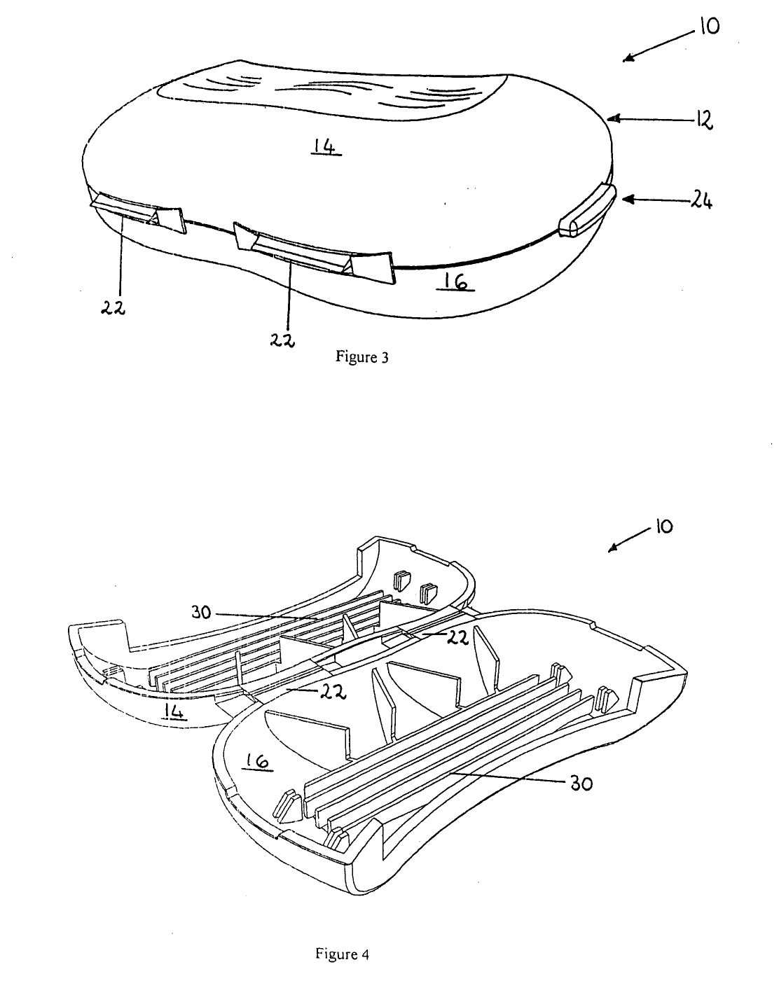

FIG. 3 shows a perspective end view of the handle of FIGS. 1 and 2;

FIG. 4 shows a perspective plan view of the handle of FIGS. 1 to 3 without the resiliently deformable zones and the releasable securing mechanism in an open condition;

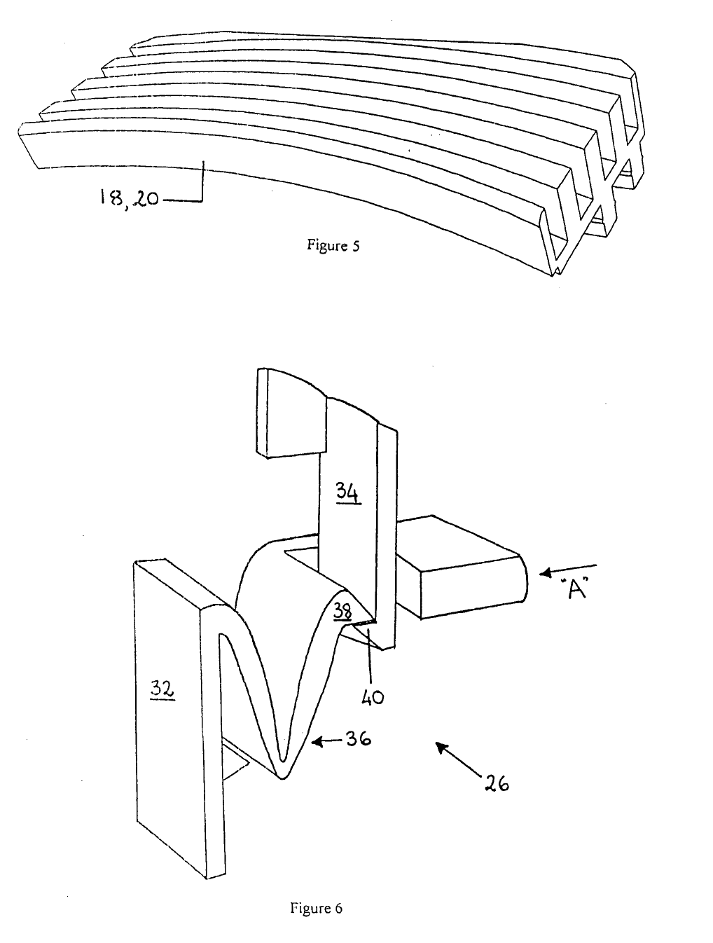

FIG. 5 shows a perspective plan view of a resiliently deformable zone to be inserted into the upper and lower portions of the handle of FIG. 4;

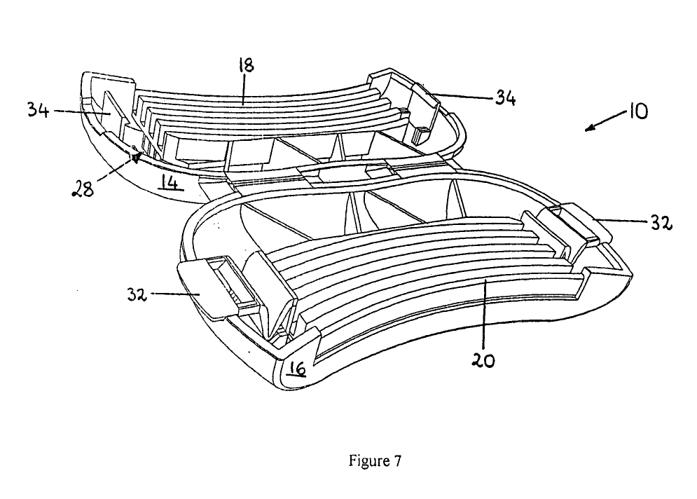

FIG. 6 shows an enlarged perspective view of the releasable securing mechanism shown in FIG. 7; and

FIG. 7 shows a perspective plan view of the handle of FIGS. 1 to 3.

In the drawings, reference numeral 10 generally indicates an embodiment of a removable handle in accordance with the present invention.

A removable handle for cookware 10 includes a casing 12 having an upper 14 and a lower 16 portion, the casing 12 being dimensioned to at least partially receive a handle of an item of cookware (not shown) and resiliently deformable zones 18 and 20 located in the casing 12, so that when the zones 18 and 20 are urged together, they grip the handle of the item of cookware.

The upper 14 and lower 16 portions of the casing 12 are hingedly connected, the hinges 22 forming an integral part of the casing 12.

The casing 12 is provided with a releasable securing mechanism 24 that secures the upper 14 and lower 16 portions of the casing 12 in a closed position as shown in FIGS. 1 to 3.

The securing mechanism 24 is in the form of a releasable catch 26.

The zones 18 and 20 are releasably attached to the upper 14 and lower 16 portions of the casing 12 means of a snap-fit arrangement 28 as shown in FIG. 7. In this way, the resiliently deformable zones 18 and 20 are replaceable should they suffer from wear and tear.

The zones 18 and 20 in the embodiment shown are of a ribbed structure as shown in FIGS. 5 and 7, to allow them to be resiliently deformable. The upper 14 and lower 16 portions of the casing 12 are also provided with ribs 30 to allow the zones 18 and 20 to be easily aligned and snugly fit into the zones 18 and 20.

The zones 18 and 20 are manufactured from a natural or synthetic heat resistant rubber.

The outer surfaces of the upper 14 and lower 16 portions of the casing 12 are shaped so as to allow easy gripping thereof by a user (not shown) as can be seen particularly well in FIG. 3.

The casing 12 is manufactured from a suitable heat-resistant synthetic plastics material, typically polypropylene.

The removable handle 10 is provided in a range of sizes to accommodate different sizes of handles. In particular, the handle 10 is shaped to accommodate handles found on pots, casserole dishes, woks, pans and the like.

Each different size of removable handle 10 is provided in a different colour to allow easy differentiation between the handles 10.

Referring now to FIGS. 6 and 7, the releasable catch 26 includes components 32 and 34. Component 32 includes a biasing means in the form of leaf spring 36. It furthermore includes an engaging formation 38 for engaging a tooth 40 of component 34 as shown in FIG. 6, when the upper 14 and lower 16 portions of the casing 12 are urged together, thereby securing the upper 14 and lower 16 portions in a closed position.

When a user wishes to remove the removable handle 10 from the handle of an item of cookware, he pushes component 32 of the releasable catch 26 in the direction of arrow “A” shown in FIG. 6, thereby compressing leaf spring 36 and allowing tooth 40 to disengage from engaging formation 38.

It is to be appreciated, that the invention is not limited to any specific embodiment or configuration as hereinbefore generally described or illustrated.

1. A removable handle for cookware including:
a casing having an upper and a lower portion, the casing being dimensioned to at least partially receive a handle of an item of cookware.

2. A removable handle as claimed in claim 1 wherein the handle includes resiliently deformable zones located in the casing, so that when the zones are urged together, they grip the handle of the item of cookware.

3. A removable handle as claimed in claim 1 or claim 2 wherein the upper and lower portions of the casing are hingedly connected.

4. A removable handle as claimed in any one of claims 1 to 3 wherein the casing is provided with a releasable securing mechanism that secures the upper and lower portions in a closed position.

5. A removable handle as claimed in claim 4 wherein the securing mechanism is in the form of a releasable catch.

6. A removable handle as claimed in claim 5 wherein the catch includes at least one toothed member having one or more teeth.

7. A removable handle as claimed in any one of the claims 2 to 6 wherein the zones are releasably attached to the upper and lower portions of the casing.

8. A removable handle a claimed in claim 7 wherein the zones are of a segmented structure to allow them to be resiliently deformable.

9. A removable handle as claimed in claim 7 or claim 8 wherein the zones are manufactured from a heat resistant material selected from the group including: wood, cork, natural rubber, synthetic rubber, nylon, any suitable polypropylene and synthetic plastics material.

10. A removable handle as claimed in any one of the preceding claims wherein at least a portion of the handle is manufactured from an insulating material.

11. A removable handle as claimed in any one of the preceding claims wherein the outer surfaces of the upper and lower portions of the casing are shaped so as to allow easy gripping thereof by a user.

12. A removable handle as claimed in claim 11 wherein the casing is manufactured from a suitable heat-resistant synthetic plastics material.

13. A removable handle as claimed in claim 11 wherein the casing is manufactured from a material of plant origin.

14. A removable handle as claimed in any one of the preceding claims wherein the removable handle is provided in a range of sizes to accommodate different sizes of handles.

15. A removable handle as claimed in claim 14 wherein each different size of removable handle is provided in a different colour.

16. A set of removable handles including one or more removable handles as claimed in any one of claims 1 to 15.

16. A removable handle according to the invention, as hereinbefore generally described.

17. A removable handle as specifically described with reference to or as illustrated in the accompanying drawings.

18. A removable handle including any new and inventive integer or combination of integers, substantially as herein described.
